(19) United States
(12) Patent Application Publication
(10) Pub. No.: US 2018/0274818 A1
(43) Pub. Date: Sep. 27, 2018

(54) REFELECTOR ASSEMBLY FOR A SOLAR COLLECTOR

(71) Applicant: Trevor Powell, Highvale (AU)

(72) Inventor: Trevor Powell, Highvale (AU)

(21) Appl. No.: 15/537,609

(22) PCT Filed: Dec. 14, 2015
(86) PCT No.: PCT/AU2015/050792

§ 371 Date: Jun. 19, 2017

(30) Foreign Application Priority Data
Dec. 19, 2014 (AU) 2014905147
Oct. 30, 2015 (AU) 2015904470

(51) Int. Cl. F24S 23/71; F24S 23/77; F24S 25/20; F24S 30/425

(52) U.S. Cl. CPC F24S 23/71; F24S 30/425; F24S 25/20; F24S 23/77

(57) ABSTRACT

The present invention provides a reflector assembly for a solar collector, the reflector assembly comprising: a sheet-like reflector, and a bracket configured to (i) maintain the reflector in a predetermined curvature, and (ii) attach the reflector to a mount. The reflector may be used in the manufacture of light weight and low cost parabolic solar collectors of the type used to concentrate solar radiation on an absorber.

### FIELD OF THE INVENTION

The present invention is in the field of solar energy collectors. In particular, the invention is directed to solar energy collectors that operate by concentrating solar radiation onto an absorber using a reflector.

### BACKGROUND

It is known in the art of renewal energy to harness power from the sun by concentrating solar radiation onto an absorber using a reflector, such as a polished metal mirror. The reflector is generally configured to concentrate solar radiation such that it is incident on, and heats, an absorber. A heat transfer medium (such as an oil) is typically pumped through the absorber where it absorbs heat energy. The absorbed heat energy is typically released at a location remote to the collector where the energy is converted into useful work. A common method for energy conversion involving pumping the heated medium to a boiler, where a heat exchanger transfers heat energy from the medium to water. Steam is collected from the boiler and directed to a rotary turbine and generator to produce electricity. Alternatively, the heated medium may be used to directly heat a building, or as input heat energy in an industrial process.

Parabolic trough collectors are a type of solar thermal collector which typically incorporate an elongate reflector having (in cross-section) a parabolic profile. The energy of solar radiation incides on the reflector parallel to its plane of symmetry and is therefore focused along a focal line. A tube containing a heat transfer medium runs the length of the trough at its focal line, the reflector oriented such that reflected solar radiation concentrates on the tube to heat the heat transfer medium. To maintain efficiency, the trough is normally rotatable about its long axis, such that the trough is able to track the sun for the majority of the day.

While clearly useful, parabolic reflectors are difficult and expensive to fabricate. In particular the support structures are complex, heavy and difficult to transport to remote sites. Many support structures are designed around a series of cantilevered arms which act to maintain a number of mirror facets the correct distance from the absorber, and also at the correct angle so as to form a reflective substantially parabolic trough.

The reflective surfaces and supporting hardware must be able to withstand the significant force inevitably occasioned on the collector by wind. Apart from dislodging the trough from the ground, wind can lead to flexing of the reflective surfaces this disrupting the focal line of the trough. Accordingly, the support structures of parabolic troughs are typically fabricated from heavy duty metal tubing.

While effective at providing an overall robust structure, prior art parabolic troughs are heavy and difficult to transport. Moreover, such supports are complex to assemble on site, and therefore not amenable to implementation in under developed countries where engineering capabilities may be lacking.

It is an aspect of the present invention to overcome or ameliorate a problem of the prior art by providing a simple, light weight and low cost support components for reflectors used in solar thermal energy collection. It is a further aspect to provide a useful alternative to prior art supports.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

In one aspect, but not necessarily the broadest aspect, the present invention provides a reflector assembly for a solar collector, the reflector assembly comprising: a sheet-like reflector, a bracket configured to (i) maintain the reflector in a predetermined curvature, and (ii) attach the reflector to a mount

In one embodiment, the reflector is elongate, and two or more brackets are disposed along the reflector.

In one embodiment, the bracket comprises an upper face having a predetermined curvature, which may be a segment of a substantially parabolic curve.

In one embodiment, the bracket comprises an aperture configured to accept a fastener, the fastener configured to fasten the reflector to the bracket.

In one embodiment, the bracket is substantially elongate and one end of the bracket is thicker than the other.

In one embodiment, the reflector assembly comprises a single bracket wherein the bracket extends for most, or substantially the entirety of the length of the sheet-like reflector.

In one embodiment, the bracket is a core structure onto which the sheet-like reflector is bonded or applied to form a composite structure.

In one embodiment, the reflector assembly comprises a support structure bonded or applied to the bracket to form a composite structure.

In one embodiment, the bracket is comprised of a lower base and an upper reflector support.

In one embodiment the lower base is fabricated from sheet metal.

In one embodiment, the upper surface of the upper reflector support has a predetermined curvature.

In one embodiment, the reflector comprises an aperture configured to accept a fastener configured to retain the reflector on the bracket.

In one embodiment, the reflector is stiffened.

In one embodiment, the reflector is a metallic material.

In one embodiment, the reflector is edge-stiffened.

In a further aspect, the present invention provides a solar collector comprising the reflector assembly as described herein, and an absorber, wherein the reflector assembly is configured to reflect solar radiation onto the absorber.

In one embodiment, the solar collector comprising a series of reflector assemblies, each reflector assembly having one or more brackets configured to retain the reflector to present a curved surface to the sun.

In one embodiment, each reflector assembly of the solar collector is configured such that all reflector assemblies act additively to provide a substantially parabolic reflector.

In one embodiment, the absorber is disposed such that most of substantially all reflected solar radiation is incident on the absorber.

A further aspect of the present invention provides a kit of parts comprising two or more reflector assemblies as described herein, or any two or more parts of a reflector assembly as described herein.

In one embodiment, the kit comprising one or more fasteners configured to fasten the reflector to the bracket.

In one embodiment, the kit comprises an absorber.

In a further aspect, the present invention provides a method of harnessing solar energy, the method comprising the step of providing the solar collector as described herein, orientating the solar collector such that solar radiation is reflected onto the absorber.

### BRIEF DESCRIPTION OF THE DRAWINGS

FIGS. 1 and 2 show a bracket for supporting a reflective sheet-like material in a preferred embodiment of the invention.

FIG. 3 shows the bracket of FIGS. 1 and 2, with a reflective sheet-like material supported and retained thereon according to a preferred embodiment of the invention.

FIGS. 4A, 4B and 4C shows a reflector structure comprising the brackets and sheet-like material supported and retained thereon according to a preferred embodiment of the invention.

FIG. 5 is an end view of the embodiment of FIG. 4A.

FIG. 6 is a diagrammatic representation of the reflector structure of FIGS. 4 and 5 demonstrating the position of the absorber, and the variable distances disposed between adjacent reflector sheets. The virtual parabolic surface approximated by the additive effect of all reflective sheets is shown as a dotted line.

FIG. 7 shows a preferred embodiment of the invention fabricated from a simple L-shaped bracket, and a separate reflector support.

FIG. 8 shows the embodiment of FIG. 7 but devoid of the mounting member upon which the brackets are mounted to more clearly show the remaining items.

FIG. 9 shows the embodiment of FIG. 8 but devoid of the reflectors to more clearly show the remaining items.

FIG. 10 shows the embodiment of FIG. 9 but devoid of the reflector supports to more clearly show the simple L-shaped portion of the brackets.

FIG. 11A shows an exploded diagrammatic view of a composite reflector of the present invention, having a single bracket extending the entire length of the reflector sheet.

FIG. 11B shows the assembled composite reflector of FIG. 11A.

### DETAILED DESCRIPTION OF THE INVENTION

After considering this description it will be apparent to one skilled in the art how the invention is implemented in various alternative embodiments and alternative applications. However, although various embodiments of the present invention will be described herein, it is understood that these embodiments are presented by way of example only, and not limitation. As such, this description of various alternative embodiments should not be construed to limit the scope or breadth of the present invention. Furthermore, statements of advantages or other aspects apply to specific exemplary embodiments, and not necessarily to all embodiments covered by the claims.

Throughout the description and the claims of this specification the word “comprise” and variations of the word, such as “comprising” and “comprises” is not intended to exclude other additives, components, integers or steps.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

Terms of orientation, such as “upper” are intended to be construed with reference to the installed orientation of the reflector assemblies. Thus, the term “upper” means generally directed toward the sun. Thus the direction which an upper surface faces may alter orientation during the day given the sun's movement across the sky

The present invention is predicated at least in part on Applicant's finding that use of a reflective sheet material supported and maintained at a desired curvature using a purpose-designed bracket is useful as a light weight, but strong component of a solar collector. Typically, in the invention multiple elongate reflector assemblies are used, the reflectors disposed side-by-side to provide a functionally substantially continuous curved surface, the curved surface typically being substantially parabolic in cross-section.

In a first aspect, the present invention provides a reflector assembly for a solar collector, the reflector assembly comprising:
a sheet-like reflector,
a bracket configured to
   (i) maintain the reflector in a predetermined curvature, and
   (ii) attach the reflector to a mount.

The reflector is typically flexible, and so is curved upon assembly with the bracket to provide the predetermined curvature. The curvature may be maintained by fastening or otherwise adhering all or part of the reflector to all or part of the bracket, such means being more fully discussed more fully infra.

In other embodiments however, the sheet like material may be a substantially rigid material and preformed generally in accordance with a desired curvature. In these embodiments the bracket acts to prevent or limit deformation of the reflector by wind, heat, cold or other factor.

The present invention is a significant departure from prior art reflector assemblies which rely on extensive framing to support a series of heavy mirrors to form a required curved reflector surface. The combination of a light weight sheet-like reflector which is supported (and optionally retained) by a bracket having a curved upper surface

The reflector will be sufficiently reflective and having sufficiently even surface properties so as reflect at least the majority of incident solar radiation so as to form a definable focal line, or a definable focal point.

As required, the reflector may be unitary such as a highly polished sheet metal, with aluminum being an exemplary material. In another embodiment the reflector is a composite material optionally having a polymeric material as a component. Suitable polymeric materials include polypropylene, polyethylene terephthalate, nylon, polythethylene and the like.

In one embodiment, the reflector is stiffened at an edge and/or at an intermediate point along the reflector. The stiffening in this context is for the purpose of preventing or limiting deformation of the reflector. For example, where the sheet-like reflector is elongate and supported by two brackets separated by a distance, the curvature may alter (or even completely flatten) in a region between the brackets. Given the light-focussing role of the reflector this will of course diminish the amount of solar radiation incident on an absorber. Stiffening improves the ability of the reflector to retain a defined curvature (such as a parabolic segment) over a distance.

Even where a reflector is inherently capable of retaining a profile between brackets, the profile may be altered by wind or thermal expansion of the material or supporting structures. Edge-stiffening has been found to provide a simple and low cost solution to deformation of the reflector between brackets.

The skilled person is entirely familiar with a number of techniques for stiffening a sheet-like material. For example, the material may comprising thickened regions (such as ribs) to improve resilience to deformation. Where the sheet-like reflector is a polymer, the thickened regions may be formed in the casting process to provide a unitary stiffened material. Alternatively, reinforcing means such as a metallic mesh or metallic ribs may be cast within the polymeric material to improve resilience to deformation. As another alternative, an elongate U-shaped cap may be fitted along opposing edges of the reflector, the cap having a greater resilience to deformation than the sheet-like material

It will be understood that any stiffening means may be disposed at or about the edges of the reflector, and/or in central regions of the material.

In embodiments where the sheet-like material comprises or consists of a sheet metal, stiffening may be achieved by a folding or roll-forming process. For example, the metal sheet may be folded over itself (to form a flattened S-shape) in a central region of the sheet to provide an integral rib consisting of three layers of metal. In another embodiment, a shallow V-shaped or U-shaped profile may be formed to provide stiffening, and optionally the wall of the V-shape or U-shape may be pressed together.

Alternatively, opposing edges of the sheet metal may be folded inwardly and onto the sheet to provide two layers of metal. It is not necessary that the edges are folded over completely, with a fold forming an angle of between about 10 degrees and about 170 degrees capable of providing some stiffening.

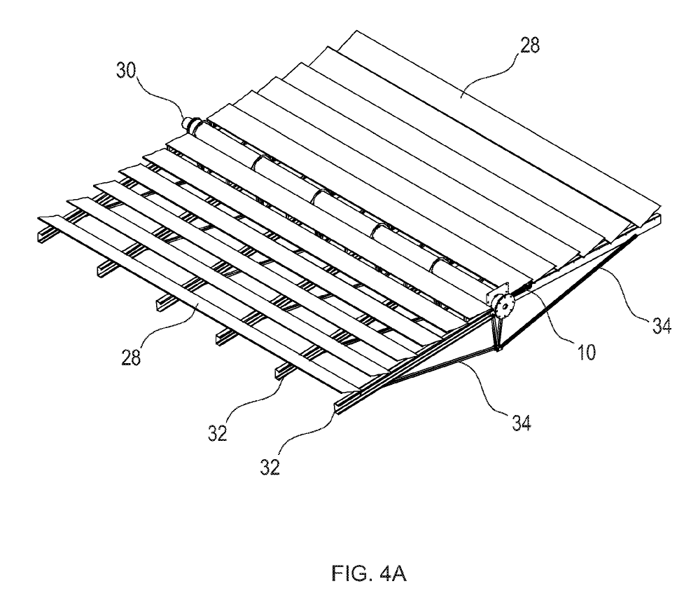

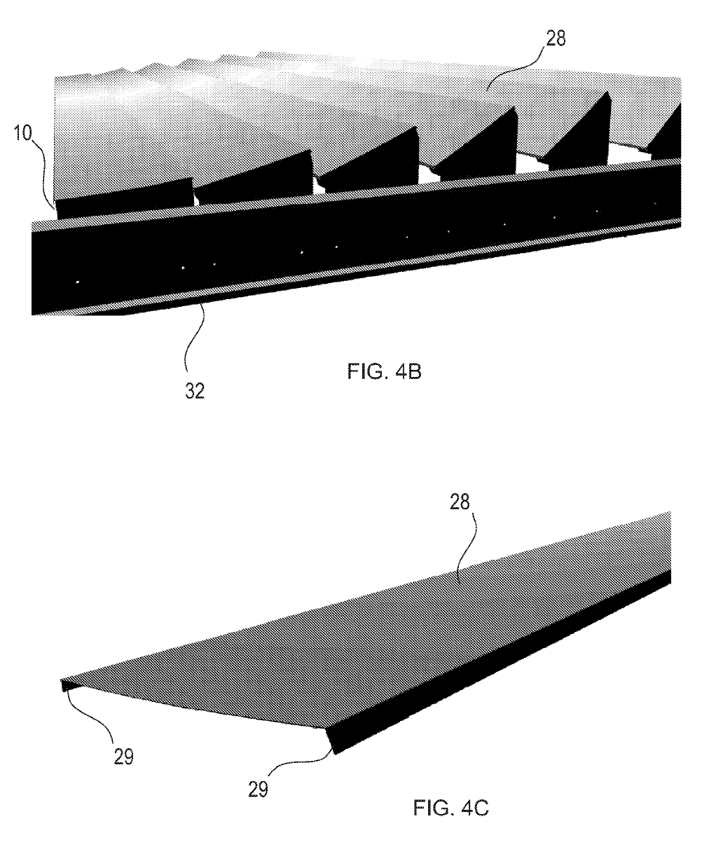

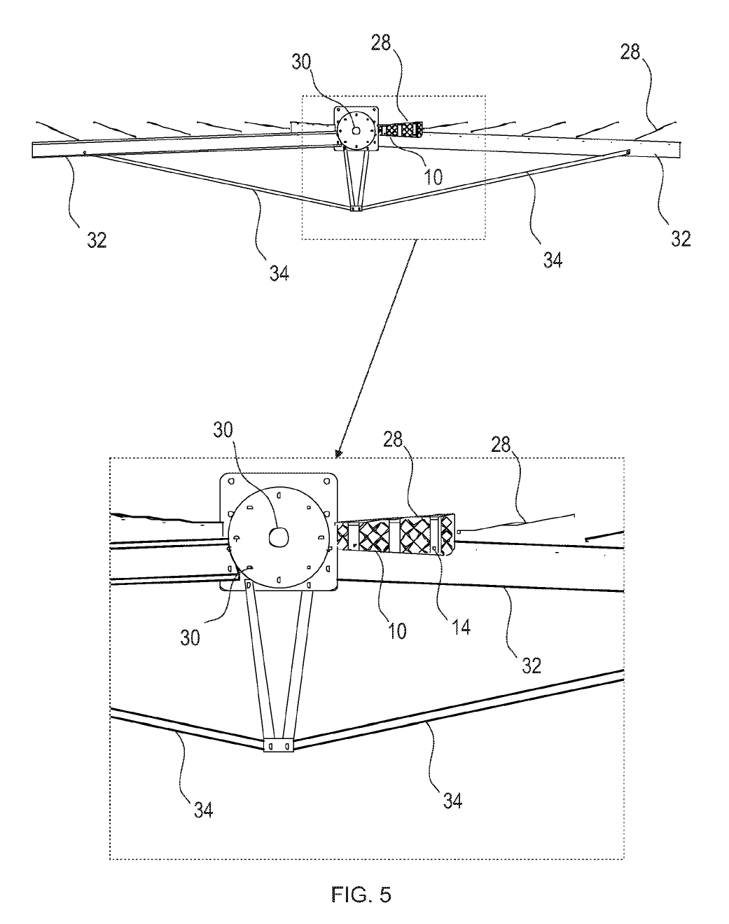

In one embodiment, the fold is made at an angle to conform to an angle provided by the bracket. Preferably, the angle of the fold is greater than or equal to about 90 degrees. Reference is made to FIG. 4B and 4C showing a highly preferred form of the embodiment, whereby the sheet material is folded along the long edges at an angle greater than 90 degrees.

A similar stiffening effect may be provided by rolling an edge into a curved profile.

Stiffening means which do not alter the reflective surface of the sheet-like reflector are preferred given that an uninterrupted reflective surface is provided. Edge-stiffening, the use of ribs and integral reinforcement are particularly preferred in that regard.

In one embodiment, the sheet-like reflector is a sheet metal layer bonded to a reflective layer. Thus, the sheet metal layer provides mechanical strength to assist in maintaining a required curvature, while the reflective layer acts to reflect incident solar radiation. The sheet metal layer is typically corrosion resistant, either inherently, or by the application of a coating such as zinc. Preferably, the sheet metal layer is a steel, coated with zinc or a zinc/aluminium alloy. An exemplary commercial product is Zincalume™ (Bluescope, Australia).

The reflective layer is preferably a highly reflective film. Such films (already known in the art) have reflective properties the same or similar to traditional glass mirrors, but are significantly lighter and less expensive than glass. Preferably, the reflective film has a solar weighted average of hemispherical reflectance of at least about 70%, 80% or 90%. One particularly suitable film is ReflecTech Mirror Film (Reflec Tech Inc, USA). This film is self-adhesive, and amenable to bonding onto a substrate sheet metal layer.

The reflector thickness may vary according to the material used, and also the distances between support brackets, the presence or absence of any stiffening means etc. Where the reflector is fabricated from a sheet metal material (such as Zincalume™, which is relatively resistant to deformation over long spans) a thickness of up to about 0.6 mm may be used.

Where pure aluminium materials are used, the reflector thickness may be in the range of 0.3 mm to 0.5 mm. Highly reflective purpose designed materials of this type are manufactured by companies such as Alanod GmbH & Co. KG (Germany) and Almeco S.p.A. (Italy). These materials have relatively low resistance to deformation and so would require brackets to be relatively closely spaced, and/or significant stiffening.

Where a plastic material is used, thicknesses of more than about 0.6 mm, or 1.0 mm, or 1.5 mm, or 2.0 mm, or 2.5 mm, or 3 mm may be required to resist deformation.

It is contemplated that thin films and flexible sheeting (including metal foils) may be utilized if placed under tension to resist deformation. For example, a polymeric film having a reflective material laminated thereon could be stretched across two brackets such that the film between the brackets is placed under tension.

For reasons of cost and practicality at least, high-tensile sheet steel with edge-stiffening is preferred.

To avoid shadowing effects, the bracket is typically disposed beneath the reflector such that it abuts the underside of reflector

The reflector may take a generally elongate form, and may be substantially rectangular. In this way, a plurality of elongate reflector assemblies may be abutted along their long edges to form a substantially continuous reflective surface.

The bracket typically has a geometry and size such that it supports substantially the entire length or width of the reflector. Where the reflector is substantially elongate the bracket may extend the entire width (i.e. directly from long edge to long edge) thereby providing support along a line, or a band.

In one embodiment, the reflector contacts an entire upper surface of the bracket. This embodiment provides a high degree of support for the reflector, and where the material is fixed to the bracket a decreased opportunity for the material to lift from the bracket in response to wind forces, for example. Accordingly, the upper surface of the bracket in such embodiments has a curvature which is the curvature desired for the reflective reflector material. In an exemplary embodiment, the curvature of the upper face of the bracket is a segment of a parabolic curve.

It is preferred that the reflector is fixed in some way to the upper surface of the bracket so as to inhibit lifting, which may disrupt the curvature of the material. In one embodiment, a fastener is used as a fixing means. The fastener may be of any type capable of mechanically linking the reflector to the bracket, although preferably providing significant resistance to lifting of the material from the bracket. Fasteners such as screws, pop rivets, press studs, split pins, and the like are all contemplated to be operable to various extents.

In one embodiment, the reflector comprises one or more perforations through which a fastener may insert.

As an alternative to fasteners, any suitable means may be used to bond the reflector to the bracket. For example, adhesives or plastic welding may be used. One particularly convenient adhesive means are the ultra high bond (UHB) and very high bond (VHB) double-sided tapes supplied by 3M (USA) . Such tapes are typically used in automotive and aerospace applications.

In one embodiment the fastener comprises a head region which is of sufficient dimension so as to inhibit or completely prevent the fastener pulling through the perforation and therefore dislodgement of the reflector from the bracket. Alternatively, the outside edge of the fastener may frictionally engage with the internal surface of the perforation in the reflector.

A similar arrangement may be provided for the bracket receiving means, which may comprise a recess or aperture into which a fastener may be inserted. The recess may have a flanged fastener entry point, with the fastener having a terminus capable of catching on the flange in response to a pull-out force.

The bracket may have a greater height at one end as compared with the other. In this context, the term “height” is intended to mean the distance from the most proximal lower face of the bracket to the upper surface of the bracket. This arrangement is amenable to embodiments whereby the upper surface of the bracket is a segment of a curve, and particularly a parabolic curve. The higher terminus of the curve segment may be disposed at or toward the bracket end of greater height, and the lower terminus of the curve disposed at or toward the bracket end of lesser height.

The present reflector assembly may comprise 2, 3, 4, 5, 6, 7, 8, 9, 10 or more brackets. The brackets are generally evenly spaced with respect to the reflective reflector material so as to provide the most consistent support or retention of the reflector. Where the reflector is relatively small, or where it is resistant to deformation only two brackets may be required (for example, along two opposing edges). It will be generally more common for the reflector to be flexible and elongate, and requiring a series of brackets disposed along the length of the reflector.

Provided a given reflector and brackets, along with the benefit of the present specification, the skilled person is capable of disposing the brackets at appropriate intervals along the reflector to achieve a desired level of retention or support.

The bracket may be fabricated from any suitably rigid material(s), such as woods (including acetylated woods, with Accoya™ being an exemplary form), metals (such as cast or machined aluminum), plastics, or synthetic resins, as are known in the art, by standard techniques. For example, the bracket may be fabricated by injection molding or other suitable technique from commercially-available material such as thermo plastic polyurethane (TPU); ionomer resin; ethylene vinyl acetate (EVA); polypropylene (PP), polyethylene terephthalate (PET), polyvinyl chloride (PVC); acrylonitrile-butadiene-styrene terpolymer (ABS); a polycarbonate and acrylonitrile-butadiene-styrene copolymer blend (PC/ABS). Other suitable materials and forming methods will be apparent to those skilled in the art.

In some embodiments of the reflector assembly, a single elongate bracket is used extending the entire length of the sheet-like reflector. Typically, the bracket takes the form of a core structure onto which the sheet like reflective layer is fixed by bonding to form a composite structure.

Such forms of the reflector may be of minimal thickness, such as less than about 3, 4, 5, 6, 7, 8, 9 or 10 mm. Reflectors of thickness between 4 to 6 mm have been found to provide sufficient resilience to deformation, while maintaining a very shallow profile. As will be appreciated, a shallow profile allows for efficiencies in packing, transport and handling to be achieved.

Reflector assemblies of the present invention may be assembled into a reflector structure. Typically, the reflector assemblies are substantially elongate and disposed side-by-side. It is preferred that the spacing between components is adapted so as to prevent or minimise blocking of any reflected solar radiation.

The brackets may themselves be supported on simple parallel elongate members extending outwardly from a central line and in opposing directions.

A reflector structure may in turn be assembled with other components to form a functioning solar thermal collector. Typically, an absorber (of any type well known to the skilled artisan) is disposed above the reflective surface of the reflective structure, in a position and at a distance such that reflected solar radiation is incident on the absorber. Where the reflector structure is configured to function as a trough reflector, and the absorber is elongate, the absorber is disposed such that its central longitudinal axis coincides with the focal line of the reflector structure.

The present reflectors and reflector assemblies in prior art solar thermal collectors and systems, and in such applications may provide advantage by way of lowering overall cost, simplifying transport, or simplifying construction. For example, the reflectors and reflector assemblies are applicable in the construction of solar energy collector systems incorporating linear Fresnel reflective means, and particularly where the reflective means are fixed such as described in the solar energy system international patent application PCT/AU2011/000460 published as WO/2011/130794.

Typically, the solar collector has tracking means configured to direct the reflective surface of the reflector structure toward the sun during the course of a day. Such means may include a motor configured to rotate the trough about an axis.

Kits of the present invention comprise reflector assemblies, in addition to other components such as an absorber, a mounting member, a frame component, a fastener, a motor, and instructions for assembly.

An advantage of the present invention is that the reflector assemblies are light weight and transportable in a “flat pack” configuration. An exemplary configuration is this regard may include a simple sheet of Zincalume folded into an “L-shape” to form a bracket. A separate reflector mounting member fabricated from plastic, metal or acetylated timber may be disposed on the upper surface of the bracket to support a reflector. The reflector mounting member has the required curvature on the upper surface, and a lower surface configured to contact an upper surface of the bracket.

The use of a separate reflector mounting member may facilitate fabrication as the required curvature may be simply moulded or otherwise formed without any constraint with regard to the bracket. Put another way, the bracket may be simply formed (such as from folded sheet metal) without any constraints with regard to forming a required curvature on the upper surface.

### DETAILED DESCRIPTION OF PREFERRED EMBODIMENTS OF THE INVENTION

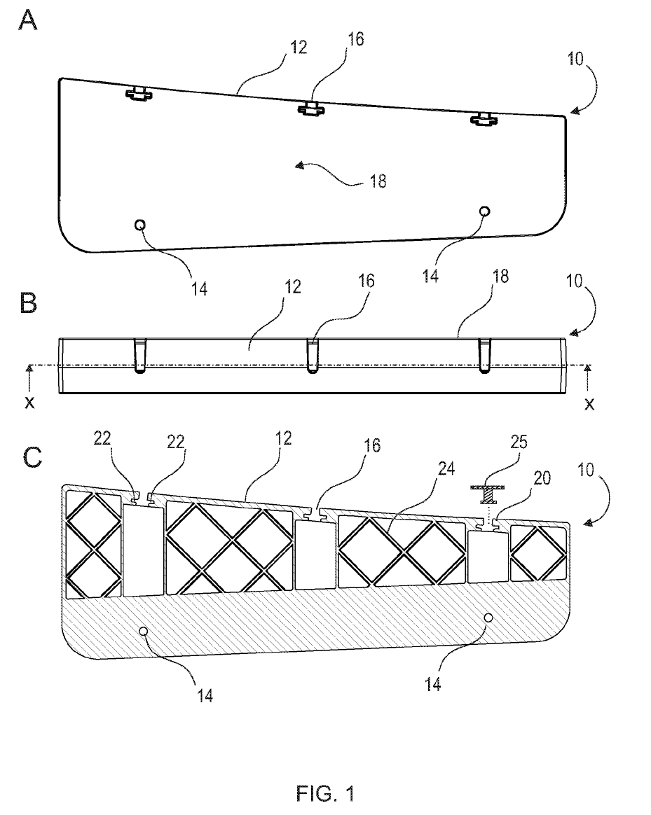

FIG. 1 shows a bracket of the present invention, configured to support and retain a polished metal reflector (not shown). Considering the lateral view (FIG. 1A) there is shown a bracket 10, having an upper surface 12 providing a substantially flat surface upon which the reflector material is disposed. While not necessarily apparent from the drawings, the upper surface 12 has a profile which is a segment of a parabola, with the steeper gradient portion of the segment present at the higher end of the bracket (to the left of bracket, as drawn) and the more shallow gradient portion of the segment present at the lower end of the bracket (to the right of bracket, as drawn). Mounting apertures 14 are present in the lower region of the bracket, allowing for the insertion of mounting members (not shown). Recesses 16, present lateral openings adjacent the upper surface 12. The openings are configured to allow a fastener to enter the recess laterally.

Considering the plan view shown in FIG. 1B is can be seen that each recess 16 is a slot having an opening to the face 18 of the bracket 10.

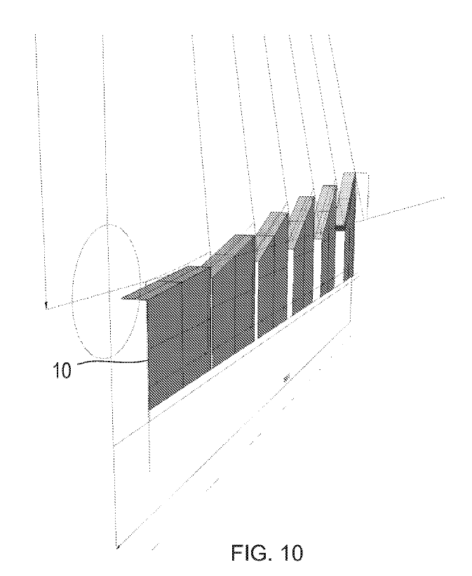

The sectional view in FIG. 10 (taken through the line x-x of FIG. 1B) shows more clearly the structure of the recesses 16, and revealing the flanges 20 which act to prevent pulling out of a fastener 25 disposed therein. The fastener 25 has a dilated lower portion that inserts within in the horizontal slot 22 formed under flange 20. Reinforcing elements 24 traverse the upper regions of the bracket 10. The lower regions of the bracket are substantially solid in the section x-x.

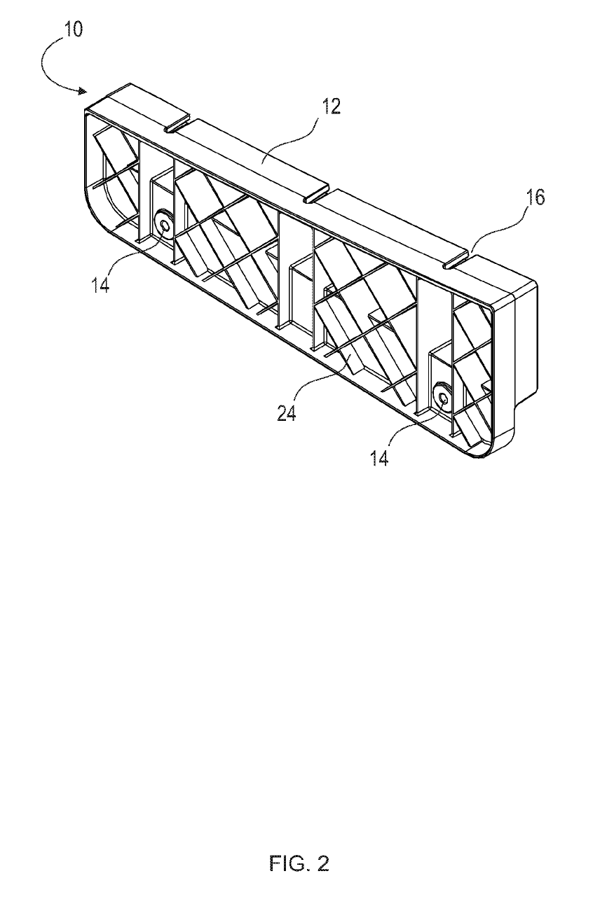

Turning now to FIG. 2, a perspective view of the bracket shown in FIG. 1 is drawn. This view more clearly displays the slotted recesses 16, which number 3 in this preferred embodiment.

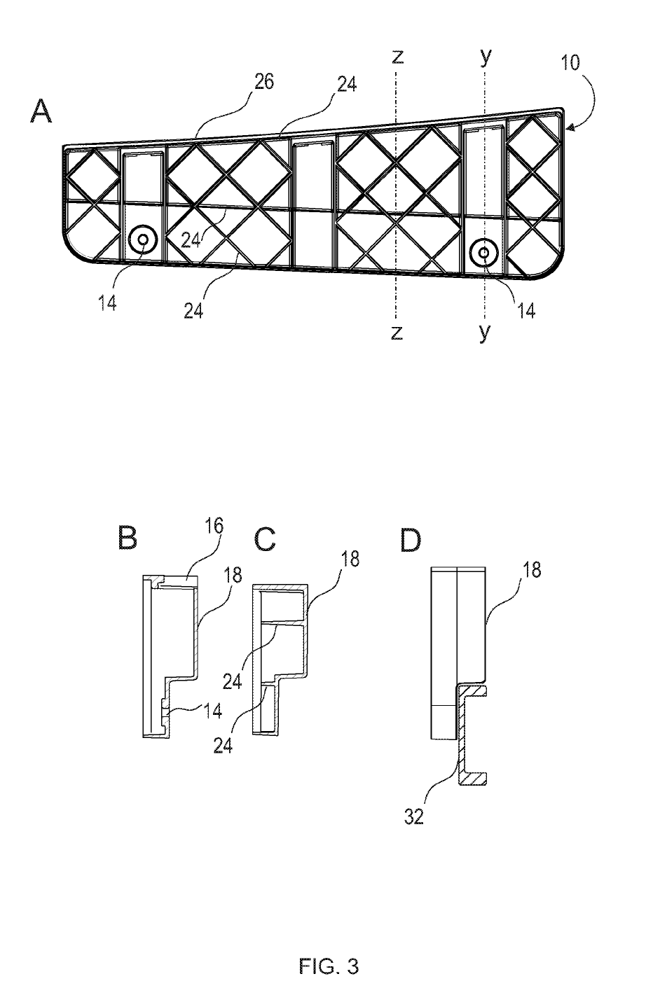

FIG. 3A is a section view showing a sheet of polished aluminum 26 disposed on the upper surface 12 of the bracket 10. The polished aluminum sheet 26 is retained by fasteners (not shown in this section) which extend through perforations in the sheet 26 (not shown). Sections through the lines y-y and z-z are shown at FIG. 3B and 3C respectively.

An end view of the bracket (the view being from the higher end at the right hand side of the page) is shown at FIG. 3D. Also shown is a mounting member 32, upon which the bracket is disposed and supported by.

FIG. 4A is a perspective view of a solar collector reflector comprising multiple sheets of highly polished aluminium 28, each sheet 28 supported and retained by a series of brackets along the length. In FIG. 4, for clarity only a single bracket 10 is shown.

A central mounting member 30 forms a central axis of rotation for the reflector.

The sheets 28 are supported at increasing angles according to the distance from the central axis 30. An increased angle is provided by a greater overall gradient from the high end to the low end of the bracket 10. Thus, closer to the central axis 30, the ratio of the high end to low end is relatively low, while for brackets used away from the central axis 30 the ratio is relatively high.

The cross-sectional profile of each sheet 28 is a segment of a parabolic curve, with the functional result of all sheets 28 being a reflective substantially parabolic trough. By this arrangement, solar radiation is focussed along a focal line. A tube-like absorber (not shown) is disposed such that the focussed solar radiation is incident upon its surface. The reflector structure is rotated about the axis

The brackets 10 are supported in turn by a series of support members 32. Bracing members 34 act to provide resistance of the entire reflector structure against deformation.

FIG. 4B shows more clearly the disposition of sheets 28 over brackets 10.

FIG. 4C shows a sheet 28, removed from the bracket 10 of FIG. 4B. It will be more clearly seen in FIG. 4C that the sheet 28 is edge-stiffened by folding along the long edges to form an angle approaching 90 degrees. The folds create two longitudinal walls 29 which extend generally downwardly past the upper surface of a bracket supporting the sheet.

A lateral view of the reflector structure of FIG. 4A is shown in FIG. 5, which more clearly shows the increasing angles of the sheets 28 according to the distance from the central axis 30 of the reflector structure. Mounting of the brackets 10 upon the mounting member 32 is also clearly shown, with fastening screws (not shown) inserted through the bracket via the mounting apertures 14 and into the member 32.

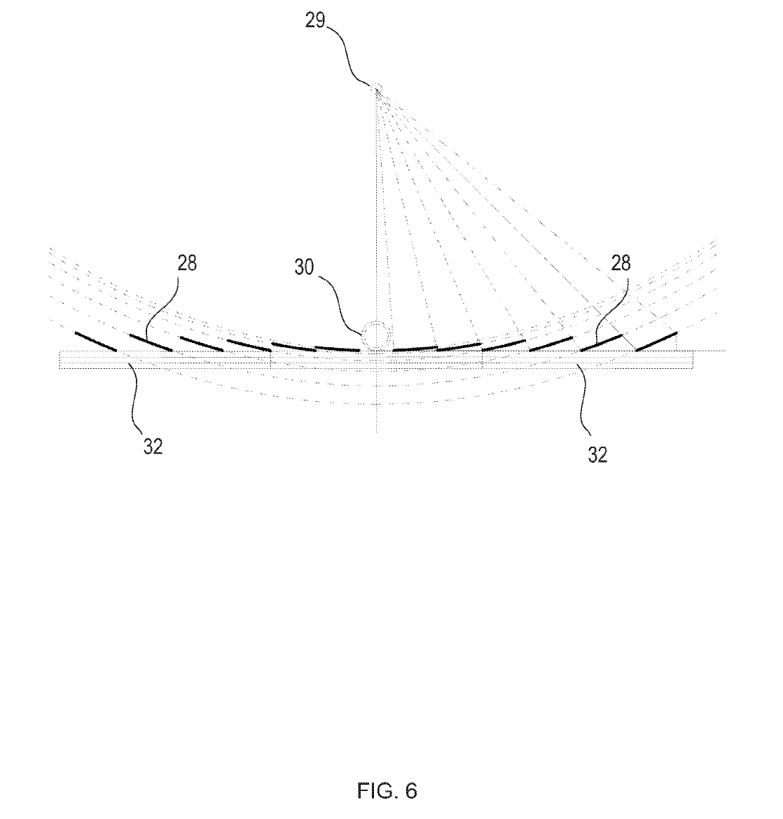

FIG. 6 is a highly diagrammatic representation of the reflector structure of FIGS. 4A and 5, including the position of the longitudinal axis of the absorber 29, and exemplary dimensions. It will be noted that the distance between adjacent reflector sheets 28 increases according to distance from the central axis, this being to ensure that a sheet does not block solar radiation reflected by an adjacent sheet.

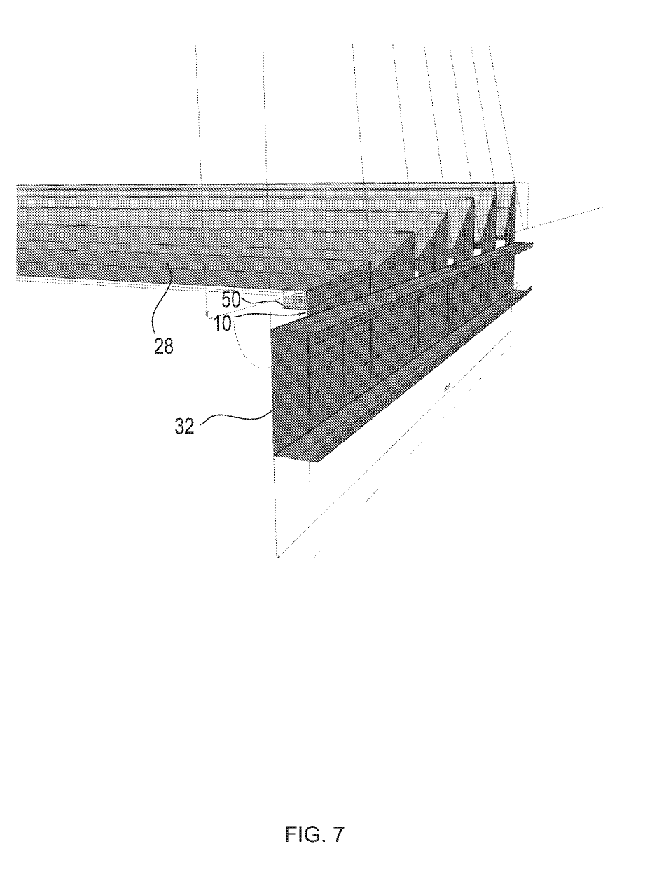

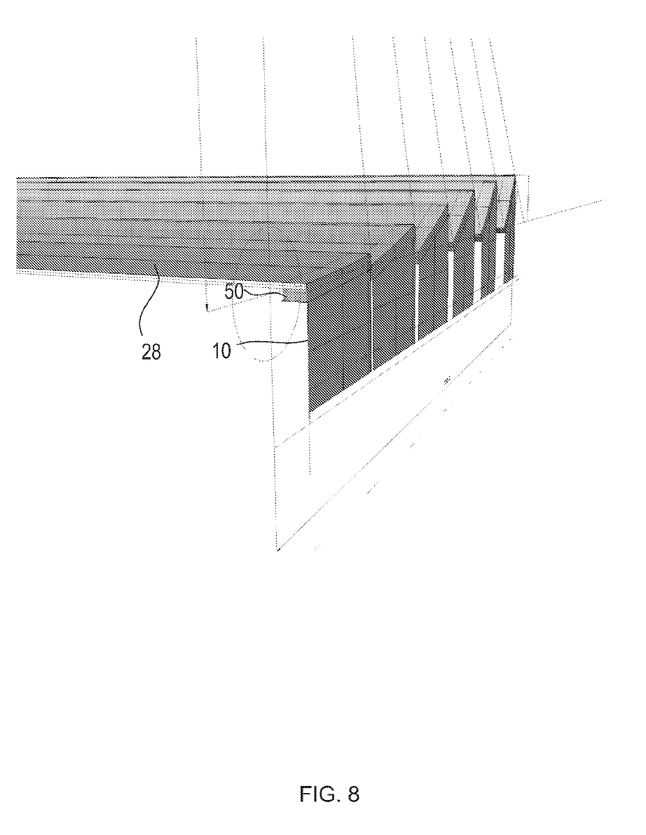

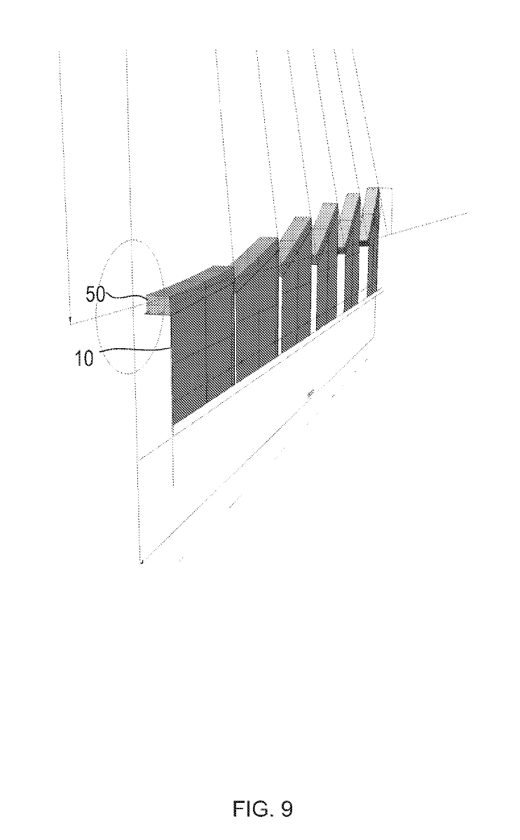

Reference is made to FIGS. 7 to 10 showing a more simplified embodiment of the invention whereby the brackets are composed by a simple L-shaped member 10 fabricated from 0.6 mm Zincalume sheets of width 300 mm. The parabolic profile is achieved through a series of profiled reflector supports 50 fabricated in plastic (or any other suitable material such as a metal), mechanically fastened to the upper surface of the L-shaped member 10. Each of the reflector supports 50 has a slightly different curve profile corresponding to the parabolic segment at that point on the curve.

The main support member 32 is a simple full length C-section purlin profile, fabricated from lightweight high-tensile Zincalume which is readily commercially available. Purlins are industry standard, of known performance, and produced globally by roll-forming means. The use of purlins allows for easy and economical access to materials in constructing the present invention.

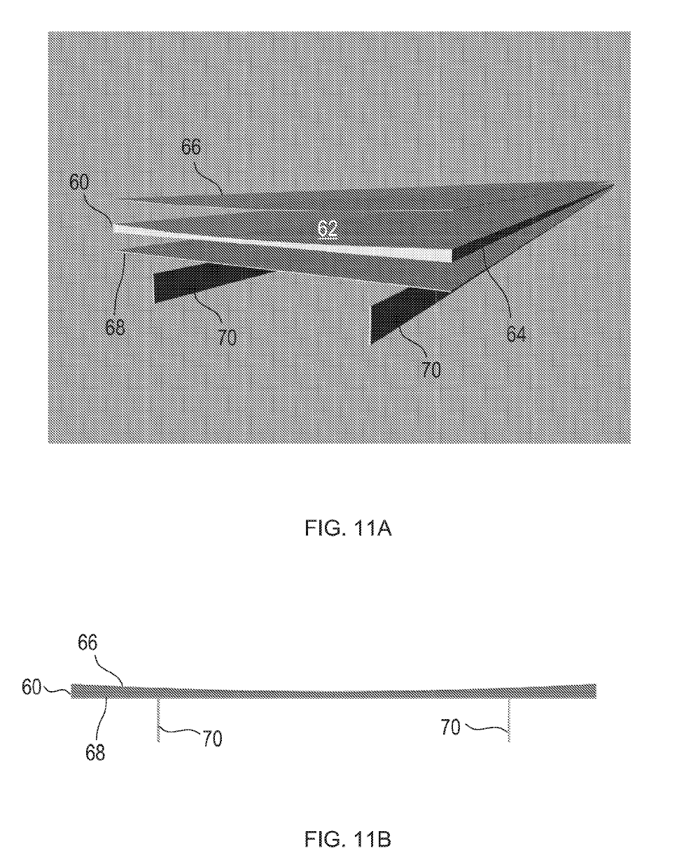

FIG. 11 shows an exploded view of a preferred composite form of the reflector assembly. The major portion of the assembly is a central core 60 as the bracket. The core 60 is elongate and extends the full length of the reflector assembly, this being distinct form other embodiments where multiple brackets are disposed along the reflector length. The core 60 may be fabricated from an inexpensive and light weight material, such as a plastic. A suitable plastic is low density polytheylene. More rigid materials such as high density polyethylene may be used, and in some case may negate the need for the lower support layer discussed below. Given the benefit of the present specification the skilled person is enabled to identify other suitable materials for the core. The core may be molded or extruded or otherwise formed by methods well known to the skilled person.

The upper surface 62 of the core 60 has a curvature which is a segment of a substantially parabolic curve. The lower surface 64 is substantially planar.

Bonded to the upper surface of the core 60 is a reflective layer 66. The reflective layer 66 may be pre-formed so as to be complimentary to the core upper surface 62. More typically, the reflective layer is flexible and capable of conforming to the parabolic curvature of the core upper surface 62 upon application and bonding thereto.

The reflective layer 66 is typically highly reflective and therefore provides a mirror-like surface. In one embodiment, the reflective layer is a high reflectivity sheet aluminium which is bonded to the core 60. It is not necessary for the reflective layer to be preformed and bonded to the core. In some embodiments, the reflective layer is formed in situ by depositing a liquid, gas, suspension or particulate matter onto the core 60 directly (or to an intermediate layer on the core) so as to form a substantially continuous reflective layer. Methods such a spraying, vapour deposition, supersonic particle deposition and the like are known techniques and potentially applicable in this form of the invention.

Bonded to the lower core surface 64 is a support layer 68, which may be a sheet metal material such as aluminium or steel. This layer may function to limit or prevent deformation of the core 60 (and therefore the reflective layer 66) as may be occasioned due to wind forces, or temperature extremes causing expansion and contraction of the core material. The support layer may be planar (as shown in the drawings) or for improved performance comprise means to increase resilience to deformation. For example, the support layer 60 may comprise a thickened section (such as a rib resulting from roll forming the metal), or a sectional angle. Reference is made to disclosure elsewhere herein further detailing means for strengthening sheet materials.

In some embodiments the lower face of the support layer 68 provides a face upon which the composite reflector may engage with a reflector support members 70.

It will be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

1. A reflector assembly for a solar collector, the reflector assembly comprising:
a sheet-like reflector, and
a bracket configured to
(i) maintain the reflector in a predetermined curvature, and
(ii) attach the reflector to a mount.

2. The reflector assembly of claim 1 wherein the reflector is elongate, and two or more brackets are disposed along the reflector.

3. The reflector assembly of claim 1 wherein the bracket comprises an upper face having a predetermined curvature.

4. The reflector assembly of claim 1 wherein the predetermined curvature is a segment of a substantially parabolic curve.

5. The reflector assembly of claim 1 wherein the bracket comprises an aperture configured to accept a fastener, the fastener configured to fasten the reflector to the bracket.

6. The reflector assembly of claim 1 wherein the bracket is substantially elongate and one end of the bracket is thicker than the other.

7. The reflector assembly of claim 1 comprising a single bracket wherein the bracket extends for most, or substantially the entirety of the length of the sheet-like reflector.

8. The reflector assembly of claim 7 wherein the bracket is a core structure onto which the sheet-like reflector is bonded or applied to form a composite structure.

9. The reflector of claim 7 comprising a support structure bonded or applied to the bracket to form a composite structure.

10. The reflector assembly of claim 1 wherein the bracket is comprised of a lower base and an upper reflector support.

11. The reflector of claim 10 wherein the lower base is fabricated from sheet metal.

12. The reflector of claim 10 wherein the upper surface of the upper reflector support has a predetermined curvature

13. The reflector assembly of claim 1 wherein the reflector comprises an aperture configured to accept a fastener configured to retain the reflector on the bracket.

14. The reflector assembly of claim 1 wherein the reflector is stiffened.

15. The reflector assembly of claim 1 wherein the reflector is a metallic material.

16. The reflector assembly of claim 1 wherein the reflector is edge-stiffened.

17. A solar collector comprising the reflector assembly of claim 1, and an absorber, wherein the reflector assembly is configured to reflect solar radiation onto the absorber.

18. The solar collector of claim 17 comprising a series of reflector assemblies, each reflector assembly having one or more brackets configured to retain the reflector to present a curved surface to the sun.

19. The solar collector of claim 18 wherein each reflector assembly is configured such that all reflector assemblies act additively to provide a substantially parabolic reflector.

20. (canceled)

21. (canceled)

22. (canceled)

23. (canceled)

24. A method of harnessing solar energy, the method comprising:
providing a solar collector comprising:
a reflector assembly, the reflector assembly comprising:
a sheet-like reflector, and
a bracket configured to:
(i) maintain the reflector in a predetermined curvature, and
(ii) attach the reflector to a mount, and
an absorber; and
orientating the solar collector such that solar radiation is reflected onto the absorber.
